(19) United States
(12) Patent Application Publication
(10) Pub. No.: US 2011/0310596 A1
(43) Pub. Date: Dec. 22, 2011

(54) 360 degree angular LED lighting

(76) Inventor: William Ahmadi, Los Angeles, CA (US)

(21) Appl. No.: 12/803,148

(22) Filed: Jun. 21, 2010

(51) Int. Cl. F21L 4/08

(52) U.S. Cl. 362/183

(57) ABSTRACT

A high mast post mounted light emitting device such as street or parking lot illuminates, and the like, has an energy source of a wind turbine with at least one blade and a solar panel with solar cells to recharge a bank of batteries when necessary, and a light source of at least one light emitting diode. A cap member seals the inner portions of the light guide housing from the elements in addition to a lens covering which also acts as a diffuser. Said light guide housing possesses at least one rectangular slot for at least one attachable LED strip. A second embodiment includes an indoor ceiling mounted post-less illumination unit. A diffusing sheet about said light guide housing may also be included to add a sparkling effect to illumination produced by said unit.

This application is entitled to the following provisional patents: 61/134,294 filed on Jul. 9, 2008, 61/188,256 filed Aug. 8, 2008, 61/210,168 filed on Mar. 16, 2009.

### FIELD OF THE INVENTION

The present invention relates to outdoor lighting of streets, parking lots and building illumination employing LED lights powered by solar, wind, or traditional power grid connections. An indoor ceiling mounted post-less version is also available.

### BACKGROUND OF THE INVENTION

### Prior Art

Many outdoor lighting systems or units exist in many different configurations; uses, and powering methods employed. The rise of the use of light emitting diodes as a light source has multiplied over the last few years and is now becoming commonplace. In part the rise of the usage of light emitting diodes stems from the amount of energy saved versus traditional power. Also many conventional lighting systems suffer from light pollution where the illumination created can produce glare and haze.

The use of alternative forms of energy to power lighting systems is also well known in the art. In particular the alternative form of energy used tends to be solar systems with panels and rechargeable batteries. The actual use of such systems has not caught on due to the inefficiencies of employing solar power alone. Many of the solar panels cannot adjust to the suns position for optimal energy absorption, and other systems would require panels too large and unsightly to meet the energy needs of said system.

Previous attempts at similar art includes U.S. Pat. No. 7,249,863 Ballarini, et al. which describes a solar powered lighting system consisting of a plurality of solar panels which recharge a battery to power said illumination source which may be a lamp or LED's. U.S. Pat. No. 5,467,257 Shalvi Nov. 14, 1995 describes a solar powered lamp whereby the solar panel is connected to a carriage driven motor to adjust the panel for optimal sunlight throughout the day.

Another approach to another use of illumination is described in U.S. Pat. No. 6,530,679 Nishioka Mar. 11, 2003, whereby a light emitting device with LED's as a light source are used preferably to display on roadside guard rails or as alarm lights at construction sites. The device can be provided with a solar battery as the power source.

A means for providing LED illumination in large quantities is described in U.S. Pat. No. 6,705,744 Hubbell et al. where large packaged quantities of LED's are retrofitted to existing 80 to 160 foot tall high-mast lighting poles.

Other patents include U.S. Pat. Nos. 7,478,919, 6,948,826, 7,090,370, 6,768,047 and 7,478,919.

Lastly, lighting systems using capacitors for energy storage are well known in the art as well. U.S. Pat. No. 5,782,552 Green et al. describes a light assembly comprising an LED, a rechargeable capacitor to power the LED unit, and a solar cell to collect energy for storage within said capacitor. The LED by means of controlled circuitry responds to power from said capacitor when ambient light falls below a pre-set level, and shuts off the LED unit when ambient light is above the pre-set level.

Thus the need arises for a more consistent powering system than those mentioned above. Solar powered illumination is greatly affected by a regions weather conditions therefore during cloudy overcast days the solar units become virtually useless unless a large storage bank of batteries or capacitors are used which is impractical for most sites.

### SUMMARY OF THE INVENTION

Solar powered lighting systems are well known in the art however such systems have not made a large headway into the marketplace due to inefficiencies that up to now have not been dealt with. The advantage of such systems whereby a solar panel charges a battery to power an illumination source, in particular, LED illumination is obvious to those trained in the art. The savings incurred due to less power usage and less maintenance are the major reasons why such systems have received more interest over recent years.

However, the disadvantages of such systems mainly occur in the area of receiving trickle charges from the solar collectors, that is, during overcast and or rainy conditions, particularly when such conditions last for a few days or more, the solar panels gather little if any solar radiation. This can be overcome by using larger panels and battery banks, to some degree, yet the larger components then become an eyesore, and a larger load is now placed on the post, thus therefore a larger post may be required, thus this solution is not practical.

An object of the present invention is to improve the illumination of an alternative energy illumination system. This object is met by the use of a 360 degree lighting guide housing a plurality of LED strips that are mounted on the inner side of said lighting guide by simply snapping on the end clamps of the LED strips to said lighting guides plurality of evenly spaced LED slot openings placed about the entire circumference of the light guide. These illuminated strips emit full angular directed radiation 360 degrees about the surface of the light guide, available in a plurality of shapes, to illuminate the unit's surroundings. The light guide housing is enclosed within a translucent or transparent casing which acts as a lens to diffuse said illumination from the light source. The V shape of said light guide housing creates an angular direction of lighting whereby a wider V shape will draw light downwards about the ground surrounding the light post.

Another object of the present invention is to prevent light pollution through the softer use of the LED illumination source, yet provide ample lighting by its 360 degree light guide and housing. Traditional illumination tubes or bulbs can project a harsh light at times that is distracting at times. The present invention seeks to provide a softer less harsh source of illumination which is sufficient to illuminate a specified area.

Another object of the present invention is to provide a stable and sufficient alternative energy source during overcast and or rainy days. This object is met by incorporating the use of wind energy with that of solar energy. A small wind turbine is mounted atop the lighting guide cap and charges two vertical shafted generators at either end of its shaft which in turn charges the units batteries. The wind turbine unit is small enough to fit along the lighting unit's structure without being an eyesore, nor without unreasonable load demands. Mounted atop the topside generator is an adjustable bracket mounted solar panel to collect solar radiation to charge the battery bank which is housed within the high mast lighting pole. The turbine blades may be C-blades, darrieus blades, or oval shaped blades and are enclosed within a cage of bars placed about the circumference of the wind turbine. The bars are spaced such that birds can not fly into the turbine blades.

Yet another object of the invention is to provide another embodiment of the present invention where conventional electrical hookups to a mains system or through a transformer whereby traditional electricity is used. The illumination source may also consist of florescent tubes where so desired. Therefore a plurality of circuit configurations may be used such as a 12 volt, 18 volt, or even a 110 volt circuit. An inverter converts the 12 or 18 volt circuit output to 110 volts.

Yet another object of the present invention is to provide a remote timer system by means of a controller which can be used to pre-set the on and off times of the outside light. In this way adjustments for time changes during the year are easily handled.

Another embodiment of the present invention is to add a sparkling effect to the light that is discharged from the illumination source. Along the outer side of the light guide housing unit is placed between the LED strips a layer of crushed ice irregular topped planar shaped backside diffuser sheets which diffuse light from the light source before it reaches the outer translucent or transparent casing fitting around said light guide. Or similarly said light guide housing can itself consist of a crushed ice irregular surface with LED strip slots.

A secondary embodiment includes an indoor lighting unit that may be traditionally powered which consists of changing the light guide's geometry whereby a V or coned shaped housing unit having a larger diameter about the top and a smaller diameter about its lower luminary end, respectively, effectively directs the outbound light downwards toward the target area for LED's. Said LED's are placed in LED slots 360 degrees about the surface area of the light guide unit. Or within the coned shaped opening of the light guide may be a clustered LED panel consisting of a plurality of LED members. Said light guide housing may be produced in a plurality of sizes.

Yet another embodiment of the 360 degree indoor lighting system is a wall mounted unit. A sectioned light guide housing is wall mounted. The room is illuminated by the 360 degree LED slots about the inner surface of the light guide in addition to the half arc of the LED cluster mounted at the light guide's distal end, whereby it illuminates the background wall, and the floor below in addition to the room.

Another embodiment includes an indoor version of this 360 light without a mast pole. Said lighting guide is mounted to the ceiling broad side attached to ceiling narrow side open. The LED strips are mounted the same within slots 360 degrees about the surface area of said light guide housing.

### BRIEF DESCRIPTION OF THE DRAWINGS

Drawings

The following description should explain the present invention in detail on the basis of drawings. However it is understood that the invention is not limited to the precise arrangements and instrumentalities shown.

FIG. 1 is a semi-sectional view of the 360 degree angular LED lighting post.

FIG. 2 is a three-dimensional view of the 360 degree angular LED lighting post.

FIG. 3 is a semi-sectional view of the 360 degree angular LED post with wind turbine mounted on post.

FIG. 4 is a tree dimensional view of the solar panel and convex lens.

FIG. 5 is a ceiling mounted view of the 360 LED light for indoor use.

FIG. 6 is a bottom view of a ceiling mounted or hanging 360 LED lighting unit.

FIG. 7 is a direct view of a 360 LED lighting unit suspended from the ceiling.

FIG. 8 is a side view of a wall mounted indoor or outdoor 360 LED light unit.

FIG. 9 is a detached view of the 360 lighting units connecting points

### DETAILED DESCRIPTION OF THE PREFERRED EMBODIMENT OF THE DRAWINGS

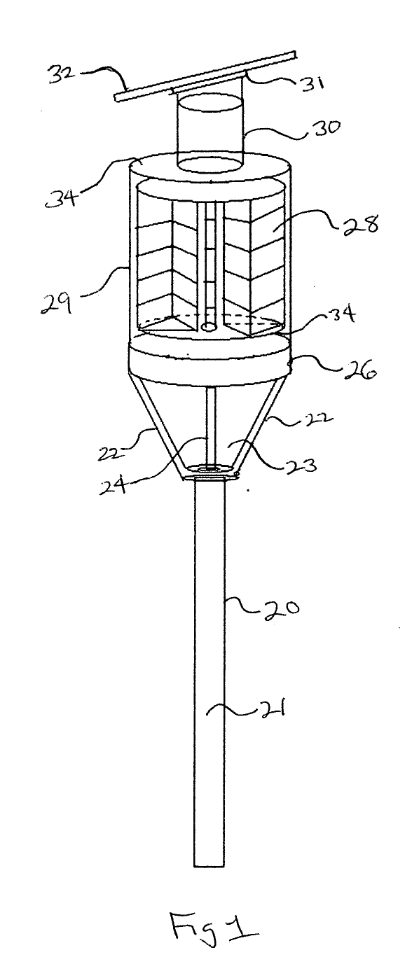

Referring to the drawings, FIG. 1 is a semi-sectional view of the 360 degree angular LED lighting post. The structure is supported by a high-mast lighting post 20 with a hollow center about its diameter whereby a bank of batteries 21 may be stored. Said high-mast lighting post 20 enters the light guide housing 23 through an opening along the base of said light guide housing 23 and acts as a base support for the upper cap 26 wherein a generator 27 is housed. Said light guide housing 23 in the preferred embodiment is shaped as a V which allows the angular direct points of illumination to be projected downwards towards the ground, and not horizontally above the ground whereby the ground is not illuminated. Said light guide housing 23 is attached to said high-mast lighting post 20 by means of a pair of circular plates are directly attached to both light guide housing 23 and lighting post 20 whereby the circular plates are screwed together and held in place by nuts.

The light guide housing 23 may be comprised of plastic, glass or metal and consists of evenly spaced and sized rectangular open LED slots 24 wherein an LED strip 25 of rectangular shaped slides and snaps into place about the diameter of the light guide housings 23 surface. Said LED strips 25 wiring may be in series, parallel or series-parallel and is ran through said high-mast lighting post 20 to the battery bank 21. An exterior lens 22 is shaped identically as the light guide housing 23 with a larger diameter so as to slide directly over said light guide housing 23. The exterior lens 22 may be translucent or transparent. The exterior lens 22 acts as a diffuser for light reflected off of the light guide housing 23, which may consist of a layer of prismatic irregular surfaced sheeting about its entire surface which acts as a second diffuser. A prismatic sheet 33 with a thickness of ⅛ to ¼ of an inch is applied to a layer of film and is vacuumed to the light guide housing 23. The LED slots 24 can be precut along with the film and prismatic sheet 33 or can be cut after the vacuum process. Said light guide housing 23 is attached to said high mast post 20 by a pair of O-ring connectors built 25 into the base of said light guide housing 23 and at the exterior of the topside of the high mast post 20. Said O-ring connectors 25 held in place by a plurality of nuts and bolts

An upper capping 26 is placed and secured over the top of the light guide housing 23 said upper capping 26 having an elongated circular shape thereof. Within the center of the upper capping 26 lies a generator 30 mounted atop the high mast lighting post 20. Said generator's 30 upper portion emerges through a circular opening of a turbine enclosure 34 at the base of said upper capping 26. The turbine enclosure 34 consists of a plurality of small grid like openings which creates a screen. Another turbine enclosure 34 tops the wind turbine 28. Both turbine enclosures 34 are supported by a plurality of turbine bars 29 equally spaced about the perimeter of said wind turbine 28. The turbine bars 29 serve both as a structural support for said turbine 28 and as a natural deterrent for wildlife, in particular birds, from entering the wind turbine 28 chamber. The turbine blades about a vertical shaft of said wind turbine 28 in FIG. 1 are angled from a central column at least 80 degrees from said column whereby said blade is bent in the reverse direction thus forming a near V-shape. At least two blades are shown within said turbine enclosure 34

Atop the wind turbine 28 lays a vertical generator housing 30 wherein a second generator 27 is attached to said wind turbine 28. Thus the wind turbine 28 consists of a plurality of blades along a single shaft which drives both generators 27 whose energy is transferred to the battery bank 21. The generator housing 30 is fitted with an adjustable panel bracket 31 where a solar panel 32 is thereby attached to gather solar radiation via its solar cells, composed from a plurality of materials, preferably a silicon derivative or of nanocrystal substance, said panel bracket 31 held in place by a central adjustable bolt of a cast metal

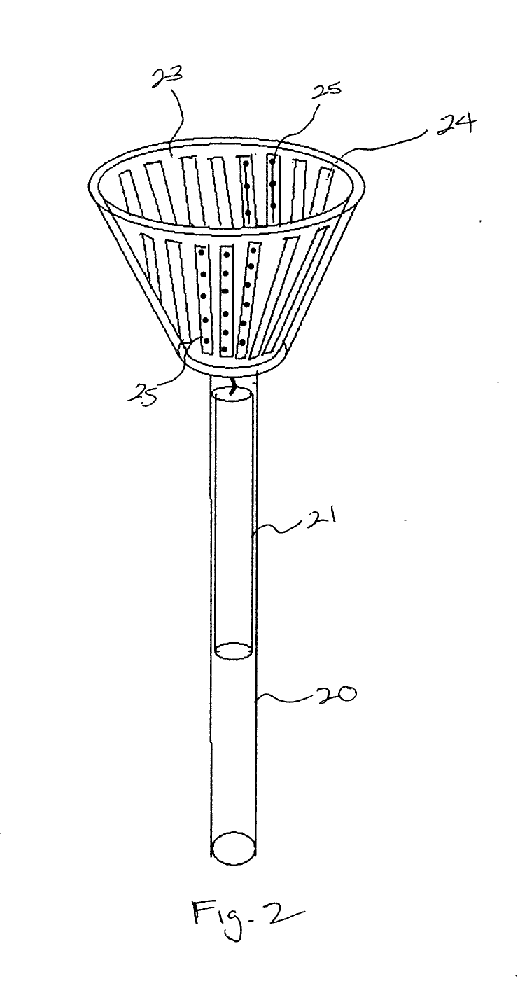

FIG. 2 illustrates a three dimensional view of the 360 degree angular LED lighting post. A high mast lighting post 20 supports the light guide housing 23 which is powered by the wind turbine and solar panel, both of which are not shown in FIG. 2. About the surface of said light guide housing 23 are a plurality of equally spaced rectangular LED slots 24 whereby a plurality of individual LED strips 25 are placed within said LED slots 24, one LED strip 25 per LED slot 24. The LED strips 25 simply snap into the specially sized LED slots 24.

Said LED strips 25 are mounted in this fashion to ease maintenance of said 360 lighting unit. A centralized wiring grid rests at the base of said light guide housing 23 where each LED strip 25 can be accessed and changed when necessary. Said wiring grid leads directly to the battery bank 21 placed within the housing of said high mast lighting post 20.

Not shown in FIG. 2 is the prismatic sheeting and film that may be attached to the portions of the light guide housing 23 between the LED slots 24 and strips 25. This prismatic sheeting acts as a diffusing element along with an exterior lens 22, also not shown in FIG. 2 wherein the lens fits over the light guide housing 23.

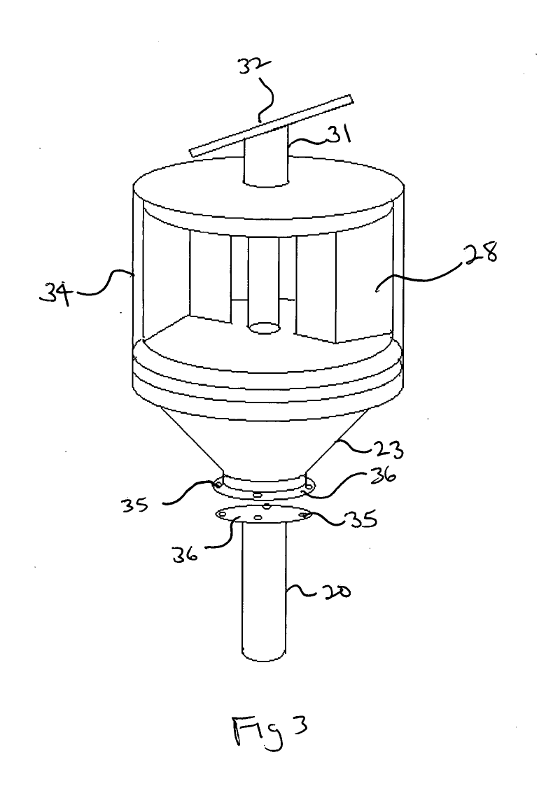

Yet another embodiment of the present invention is described FIG. 3 is a semi-sectional view of the 360 degree angular LED post with wind turbine 28 unit attached to the high mast post 20 by a bracket securing said wind turbine 28 to said post 20 and two end caps 36 attached at an upper generator 30 and a lower generator 30. Enclosed between the pair of generators 30 is the wind turbine 28 which may consist of a plurality of blade types. Said wind turbine 28 is enclosed by a plurality of turbine bars 29 which add structural support to said wind turbine 28 and said generators 30 and in addition act as a passage way for electrical wiring required by the wind turbine 28. A pair of turbine enclosures 34 having circular dimensions one at the top, the other at the base of said wind turbine 28 separate the generators 30 from the wind turbine 28 blades therein, said generators 30 capped off by a pair of circular metallic end cap 36 sheets identical in size to that of the turbine enclosures 34.

The end caps 36 are attached to said generators 30 by either screws or nuts and bolts and are thereby attached to a pair of brackets which attach the turbine 28 to said high mast post 20 at an altitude slightly higher than the mid section of said post 20. Built in at the height of said high mast post 20 is a washer ring 35 which extends perpendicularly from the top of said post 20. A second built-in washer ring 35 extending from the base of the light guide housing 23 is joined to the first washer ring 35 secured by nuts and bolts or screws, with at least one pin to help secure the structure in place.

Enclosing the base of said high mast lighting post 20 is a squared shaped foundation structure wherein the illumination unit houses a plurality of batteries 38 on the left side and a plurality of batteries 38 on the right side. Within the center of the lighting post 20 is placed a controller unit 39 whereby output from said generators 30 and solar panel 32 are regulated to maintain the batteries 38 charge level for at least a three day store of energy at any given time.

Connected to said high mast post 20 by the washer rings 35 is the light guide housing 23 which is formed in a V-shape to channel illumination down towards the ground, said light guide housing 23 composed of a plurality of evenly spaced LED slots 24 wherein an LED strip 25 is individually placed in each LED slot 24. An exterior lens 22 encloses the light guide housing 23 and consists of translucent or transparent polycarbonate or glass and acts as a secondary diffuser of the light source exiting said light guide housing 23.

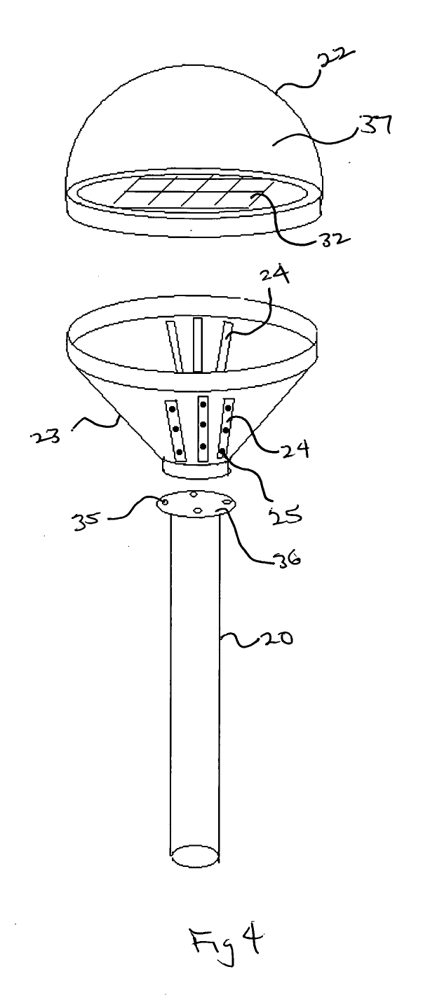

Atop the light guide housing member attached to the inner mast post 20 is a washer ring 35 whereby according to FIG. 4 a solar panel 32 has an underside washer ring 35 which is attached to the post 20 washer ring 35 whereby said solar panel 32 and cells collect radiant energy in addition to the collected wind energy produced by the wind turbine 28. A convex lens 37 caps the solar panel 32 and light guide housing 23. Its convex nature eliminates the problem of nesting birds sitting atop said lens 37 possibly obscuring the entrance of radiant energy through said lens 37 to the solar panel 32.

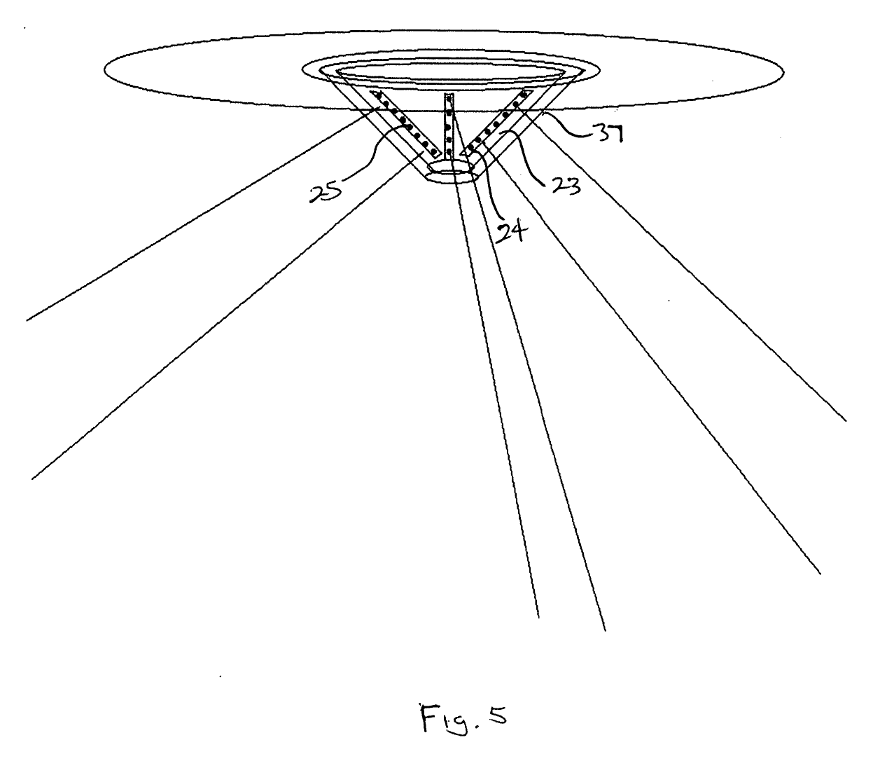

Another embodiment of the present invention is illustrated in FIG. 5 wherein a ceiling mounted view of the 360 LED lighting unit for indoor use is displayed. A ceiling mounting bracket is secured to the ceiling by screws or nuts and bolts therein. The light guide housing 23 is secured to the ceiling bracket by a plurality of fasteners. About the surface of the light guide housing are LED slots 24 360 degrees along the surface of said light guide housing 23. LED strips 25 snap into place within the specifically sized rectangular shaped LED slots 24. The light housing guide is enclosed within the exterior lens 37 and the unit may be powered by traditional power in this particular embodiment.

FIG. 6 is a bottom view of either the ceiling mounted or ceiling supported hanging light unit. Here the light guide unit is shown as possessing a plurality of LED slots 24 and LED strips 25 within said LED slots 24, 360 degrees about the surface of said light guide housing 23 unit. The conically shaped light housing guide 23 assures an illumination stream that is radiated primarily directionally downwards where illumination is primarily needed.

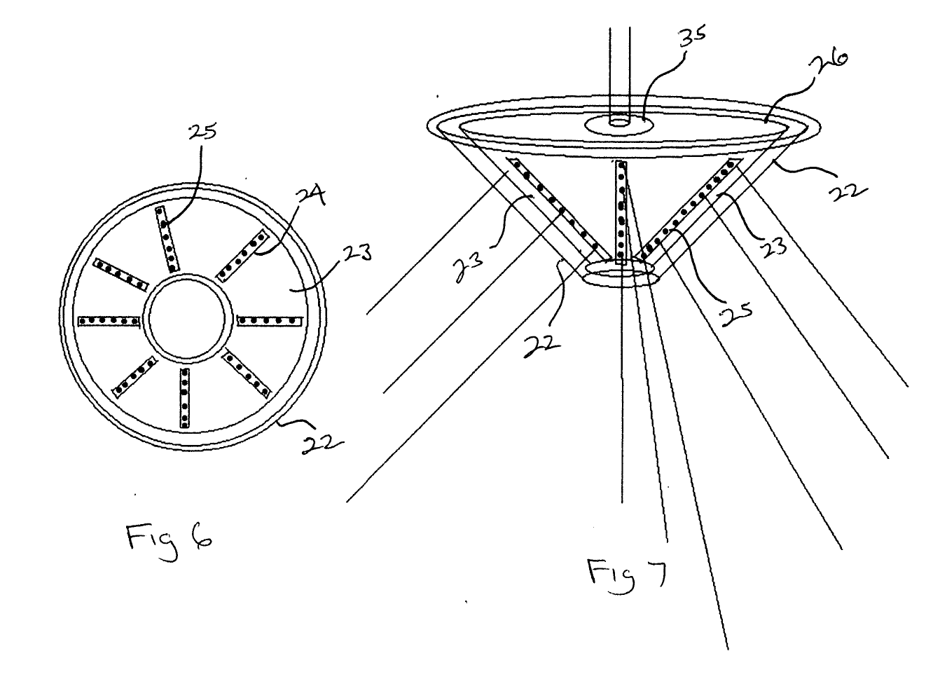

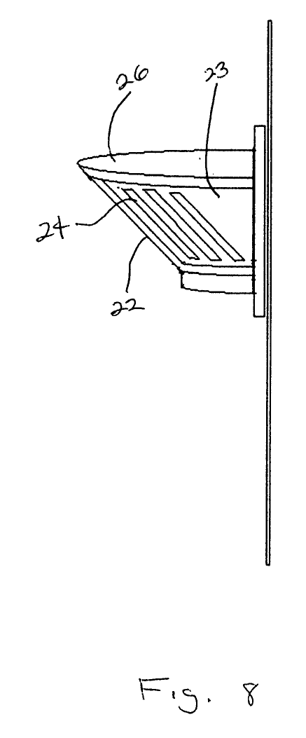

FIG. 7 illustrates another indoor embodiment of the 360 LED lighting unit which is suspended from the ceiling by means of a suspension post attached to a ceiling bracket on one end and to the upper capping 26 by a washer ring 35 on the other end. Said upper capping 26 provide a cover for the top of the light guide housing 23 and fits over the exterior lens 22. A plurality of LED strips 25 about the surface of said light guide housing 23 illustrates the conical shape of this embodiment designed to direct light not only across a room but downwards through the light guide housings 23 base opening. Such embodiment of the 360 degree light unit may be powered by traditional means.

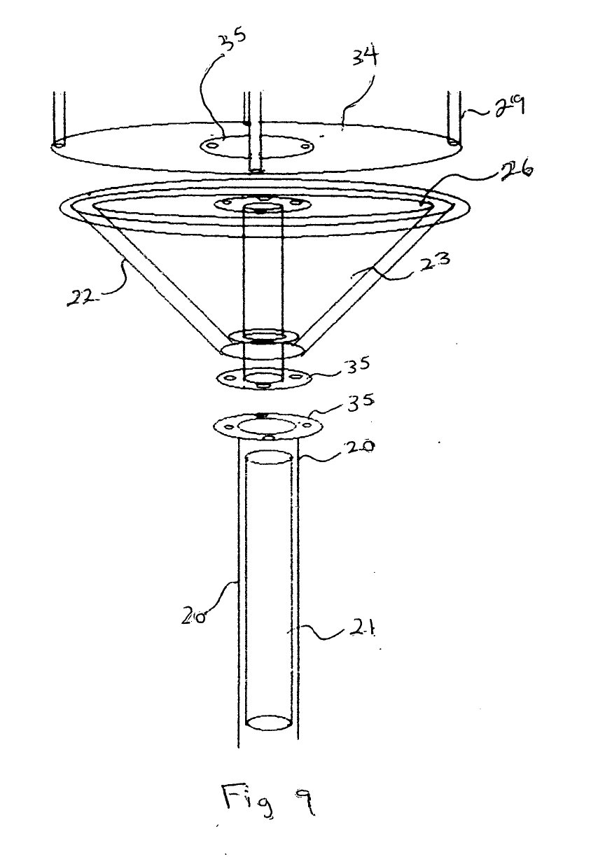

FIG. 8 is yet another embodiment of the present invention whereby a side view of a wall mounted lighting unit for use indoors or outdoors is related. A light guide housing 23 is found here in a sectional piece whereby it is cut in half and mounted to a wall either indoors or outdoors both for illumination and decorative functions, such as a hallway area full of 360 LED wall mounted lights which may radiate a plurality of colors, or may be used to illuminate paintings or other wall mounted art.

Illustrated here for practical purposes are the LED slots 24 wherein the LED strips 25 are located within the light guide housing 23 which is topped by an upper capping 26 sealed within the exterior lens 22 which is both a lens and a diffuser of illumination.

FIG. 9 illustrates a detached view of the 360 lighting unit's connection points where the lower turbine enclosure 34 is shown without the turbine. The turbine bars 29 are partially illustrated around the perimeter of said turbine enclosure 34 and act as a structural support to the aforementioned turbine. A washer ring 35 lies at the center of the topside of said turbine enclosure 34 and is fastened to the washer ring 35 by screws, or nuts and bolts, and may include at least one fastening pin. Said turbine enclosure 34 comes to rest atop the upper capping 26 of the light guide housing 23 and the exterior lens 22 where not shown along the surface of said light guide housing 23 are the LED slots and LED strips where illumination is employed. At the base of said light guide housing 23 lies the horizontally placed washer ring 35 wherein said washer ring 35 of the high mast post 20 meets, both washer rings 35 fastened together by screws, nuts and bolts and at least one pin may be inserted to increase the structural integrity of the lighting unit.

In this particular embodiment of the present invention a bank of batteries 21 reside within said high mast post 20 and are charged when necessary by both the wind turbine and the solar panel both of which are not shown in FIG. 9.

The drawings provide a reasonable diversity of applications, both indoors and outdoors which apply to the present invention.

### LIST OF DRAWING REFERENCES

20. High mast lighting post
21. Batteries
22. Exterior lens
23. Light guide housing
24. LED slot
25. LED strip
26. Upper capping
27. Prismatic sheeting
28. Wind Turbine
29. Turbine bars
30. Generator
31. Panel bracket
32. Solar panel
33. Prismatic sheeting
34. Turbine enclosure
35. Washer/o-ring connectors
36. End caps
37. Convex lens

### Conclusions, Ramifications and Scope

Although the above description contains many specifications, these should not be construed as limiting the scope of the invention but merely providing illustrations of the preferred embodiments of the invention. Thus the scope of the present invention should be determined by the appended claims and their legal equivalents rather than by the examples given.

I claim:

1. A 360 degree LED lighting post wherein a light guide housing unit consists of at least one opening slot for at least one LED light;
an upper cap atop the light guide housing which houses a generator;
a wind turbine with at least one blade atop the light housing unit;
a housing for the upper generator which also acts as a support structure for the solar panel;
a translucent or transparent exterior lens enclosing the light housing unit;
a high mast lighting pole which acts as a storage for at least one battery.

2. A 360 degree LED lighting post according to claim 1, wherein said light guide housing unit comes in a plurality of shapes.

3. A 360 degree LED lighting post according to claim 1, wherein said light guide's preferred embodiment has a conic or V-shape.

4. A 360 degree LED lighting post according to claim 1, wherein said light guide housing consists of a plastic, metal or glass body with a plurality of open slots about its area.

5. A 360 degree LED lighting post according to claim 4, wherein said light guide housing has a plurality of open slots which are spaced evenly about said housing 360 degree area and are rectangular in shape. Said housing may display a prismatic crushed ice irregular surfaced diffuser about its non slot area.

6. A 360 degree LED lighting post according to claim 1, wherein said LED lights are contained on strips consisting of a plurality of LED members.

7. A 360 degree LED lighting post according to claim 6, wherein said LED lights may be white, red, green or a variety of colors in display.

8. A 360 degree LED lighting post according to claim 6, wherein said LED strips may be wired in series, parallel or series-parallel. Said wiring of any above chosen configuration runs through lighting post to said batteries.

9. A 360 degree LED lighting post according to claim 1, wherein upper cap acts as both an enclosure for the light guide housing and mounting area for a generator.

10. A 360 degree LED lighting post according to claim 1, wherein said light guide housing has an opening at its base to receive the upper portion of the lighting post which supports said upper cap and said generator within, and may possess a layer of prismatic diffusing sheeting to enhance visibility

11. A 360 degree LED lighting post according to claim 1, wherein said wind turbine is housed atop said light housing cap within its own enclosure.

12. A 360 degree LED lighting post according to claim 11, wherein said wind turbine enclosure consists of a plurality of metallic bars evenly spaced about to prevent birds from entering said turbine while allowing wind flow to said turbine.

13. A 360 degree LED outdoor lighting post according to claim 1, wherein said wind turbine is composed of a plurality of blade types.

14. A 360 degree LED lighting post according to claim 1, wherein said wind turbine powers one or two generators at either end of its shaft. Said shaft acts to house electrical wiring from said generators.

15. A 360 degree LED lighting post according to claim 14, wherein said wind turbine generators charge a battery bank.

16. A 360 degree LED lighting post according to claim 1, wherein said upper generator housing also acts as a mounting point for a solar panel collector.

17. A 360 degree LED lighting post according to claim 1, wherein said solar panel is attached to the upper generator housing by means of an adjustable bracket.

18. A 360 degree LED lighting post according to claim 1, wherein said exterior lens is shaped as the light guide housing, with a slightly larger circumference and area, and slides over said light guide housing secured by the housings cap.

19. A 360 degree LED lighting post according to claim 18, wherein said exterior lens is either translucent or transparent and diffuses directed angular light outwards towards the viewer.

20. A 360 degree LED lighting post according to claim 1, wherein said high mast lighting post has a hollow interior which acts as a storage bank for one or more batteries.

21. A 360 degree LED lighting post according to claim 1, wherein said light Guide housing may be mounted indoors directly to ceiling or suspended by a shaft, rod or by chains.
